(19) United States
(12) Patent Application Publication
(10) Pub. No.: US 2026/0237046 A1
(43) Pub. Date: Aug. 13, 2026

(54) ABNORMAL REGION DETECTION APPARATUS, ABNORMAL REGION DETECTION METHOD, AND NON-TRANSITORY COMPUTER-READABLE STORAGE MEDIUM

(71) Applicant: Mitsubishi Electric Corporation, Tokyo (JP)

(72) Inventors: Eri MORIYA, Tokyo (JP); Takafumi KOIKE, Tokyo (JP)

(73) Assignee: Mitsubishi Electric Corporation, Tokyo (JP)

(21) Appl. No.: 19/636,200

(22) Filed: Apr. 1, 2026

Related U.S. Application Data
(63) Continuation of application No. PCT/JP2023/036855, filed on Oct. 11, 2023.

(51) Int. Cl. G06T 7/00; G01N 21/88; G01N 21/952; G06V 10/25; G06V 10/74; G06V 10/75; G06V 10/764

(52) U.S. Cl. CPC G06T 7/0002; G01N 21/8851; G01N 21/952; G06V 10/25; G06V 10/759; G06V 10/761; G06V 10/764

(57) ABSTRACT

An abnormal region detection apparatus includes: abnormal region detection circuitry to detect abnormal region candidates, which are candidates for abnormal regions, from image features included in an electric-wire-region electric-wire image; abnormal periodicity determination circuitry to determine the periodicity of the abnormal region candidates; abnormal image comparison circuitry to compare images of the respective abnormal region candidates that exhibit periodicity and calculate the degree of similarity of the respective abnormal region candidate; and normal region removal circuitry to exclude, as normal regions, the abnormal region candidates whose degree of similarity calculated by the abnormal image comparison circuitry is higher than a predetermined threshold, and to output, as an abnormal region, the abnormal region candidate other than the excluded abnormal region candidates.

### CROSS-REFERENCE TO RELATED APPLICATION

This application is a continuation application of International Application No. PCT/JP2023/036855 having an international filing date of Oct. 11, 2023, which is hereby expressly incorporated by reference into the present application.

### TECHNICAL FIELD

The present disclosure relates to an abnormal region detection apparatus, an abnormal region detection method, and an abnormal region detection program.

### BACKGROUND

There is a technique for detecting abnormal regions such as damage of electric wires by analyzing images of the electric wires such as power lines. However, in some cases, members such as anti-snow-adhesion rings for suppressing snow accretion on the electric wires are attached to the electric wires at regular intervals, and in such cases, there is a risk that these members, such as the anti-snow-adhesion rings, may also be detected as abnormal regions.

Patent Reference 1 discloses a technique in which an electric-wire region is obtained from image data captured from a helicopter, a representative value of each pixel in the horizontal direction is calculated, a fiber-optic crossing portion is identified based on changes in the value, and an abnormality detection method is changed depending on whether such a crossing is present. In Patent Reference 1, when a specified number or more of abnormalities are detected from the image data, periodicity of the abnormalities is determined, and if periodicity is present, the threshold for abnormality detection is lowered so that the abnormalities will not be detected as abnormalities.

Patent Reference 1: Japanese Unexamined Patent Application Publication No. 2007-310828

### SUMMARY

However, the technique described in Patent Reference 1 has a risk that, when the threshold is lowered because a plurality of abnormal regions exhibit periodicity, minor abnormalities other than normal regions may be simultaneously removed. In addition, in Patent Reference 1, when the threshold for abnormality detection is high, structures such as anti-snow-adhesion rings that are present at regular intervals on the electric wires may be detected as abnormalities, resulting in complications in verifying the detection results and in subsequent processing.

It is an object of the present disclosure to provide an abnormal region detection apparatus, an abnormal region detection method, and an abnormal region detection program that are capable of distinguishing abnormal regions from normal regions even when a plurality of abnormal regions exhibit periodicity.

An abnormal region detection apparatus according to an aspect of the present disclosure includes: abnormal region detection circuitry to detect abnormal region candidates from image features included in a captured image of an inspection object having an elongated shape, the abnormal region candidates being candidates for abnormal regions; abnormal periodicity determination circuitry to determine periodicity of the abnormal region candidates, and to output, as an abnormal region, the abnormal region candidate that does not exhibit periodicity; abnormal image comparison circuitry to compare images of the respective abnormal region candidates that exhibit periodicity, and to calculate a degree of similarity of the respective abnormal region candidates; and normal region removal circuitry to exclude, as normal regions, the abnormal region candidates having a high degree of similarity calculated by the abnormal image comparison circuitry, and to output, as an abnormal region, the abnormal region candidate with the normal regions excluded.

An abnormal region detection method of an aspect of the present disclosure is an abnormal region detection method executed by a computer, includes: a step of detecting abnormal region candidates, which are candidates for abnormal regions, from image features included in a captured image of an inspection object having an elongated shape; a step of determining periodicity of the abnormal region candidates to output, as an abnormal region, the abnormal region candidate that does not exhibit periodicity; a step of comparing images of the respective abnormal region candidates that exhibit periodicity to calculate a degree of similarity of the respective abnormal region candidates; and a step of excluding, as normal regions, the abnormal region candidates whose calculated degree of similarity is high to output, as an abnormal region, the abnormal region candidate with the normal regions excluded.

An abnormal region detection program of an aspect of the present disclosure causes a computer to execute: a step of detecting abnormal region candidates, which are candidates for abnormal regions, from image features included in a captured image of an inspection object having an elongated shape; a step of determining periodicity of the abnormal region candidates to output, as an abnormal region, the abnormal region candidate that does not exhibit periodicity; a step of comparing images of the respective abnormal region candidates that exhibit periodicity to calculate a degree of similarity of the respective abnormal region candidates; and a step of excluding, as normal regions, the abnormal region candidates whose calculated degree of similarity is high to output, as an abnormal region, the abnormal region candidate with the normal regions excluded.

According to the present disclosure, it is possible to provide the abnormal region detection apparatus, the abnormal region detection method, and the abnormal region detection program that can distinguish abnormal regions from normal regions even when a plurality of abnormal regions exhibit periodicity.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a functional block diagram showing an abnormal region detection apparatus according to a first embodiment;

FIG. 2 is a schematic diagram showing an example of an electric wire as an inspection target;

FIG. 3 is a graph in which the horizontal axis represents the length of the electric wire, and the vertical axis represents the average luminance value of each column in the electric-wire-region electric-wire image;

FIG. 4 is a hardware configuration diagram showing the abnormal region detection apparatus according to the first embodiment;

FIG. 5 is a flowchart showing an example of the determination processing performed by the abnormal region detection apparatus according to the first embodiment;

FIG. 6 is a functional block diagram showing an abnormal region detection apparatus according to a second embodiment;

FIG. 7 is a flowchart showing an example of the determination processing performed by the abnormal region detection apparatus according to the second embodiment;

FIG. 8 is a functional block diagram showing an abnormal region detection apparatus according to a third embodiment;

FIG. 9 is a flowchart showing an example of the determination processing performed by the abnormal region detection apparatus according to the third embodiment;

FIG. 10 is a functional block diagram showing an abnormal region detection apparatus according to a fourth embodiment; and

FIG. 11 is a flowchart showing an example of the determination processing of the abnormal region detection apparatus according to the fourth embodiment.

### DETAILED DESCRIPTION

Hereinafter, an abnormal region detection apparatus according to an embodiment will be described with reference to the drawings. The following embodiments are merely examples, and it is possible to appropriately combine or modify the embodiments as needed.

### First Embodiment

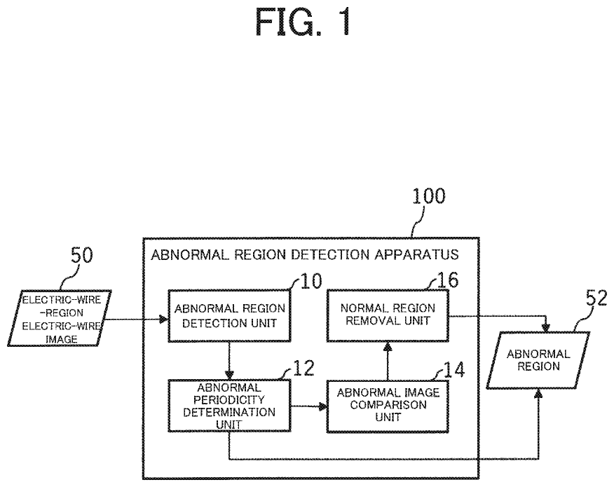

FIG. 1 is a functional block diagram showing an abnormal region detection apparatus 100 according to a first embodiment. The abnormal region detection apparatus 100 includes: an abnormal region detection unit 10 (e.g., abnormal region detection circuitry) that detects abnormal region candidates, which are candidates for abnormal regions, from image features of an electric-wire-region electric-wire image 50 that has been input; an abnormal periodicity determination unit 12 (e.g., abnormal periodicity determination circuitry) that determines the periodicity of the abnormal region candidates when a plurality of abnormal region candidates have been detected; an abnormal image comparison unit 14 (e.g., abnormal image comparison circuitry) that performs image comparison between the abnormal region candidates and determines the degree of similarity between the abnormal region candidates when the abnormal region candidates have periodicity; and a normal region removal unit 16 (e.g., normal region removal circuitry) that outputs, as an abnormal region 52, a result obtained by excluding, from the abnormal regions detected by the abnormal region detection unit 10, the abnormal region candidates having a high degree of similarity to each other as normal regions.

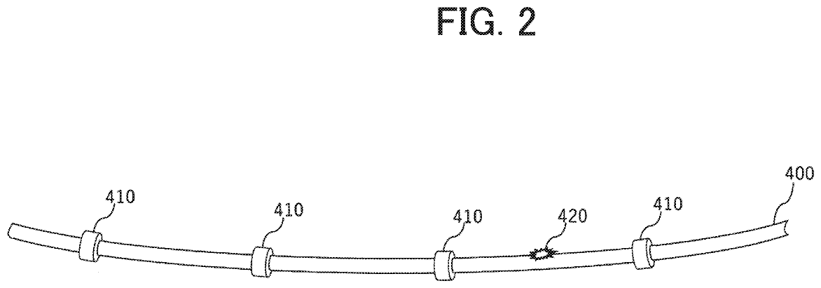

The electric-wire-region electric-wire image (hereinafter referred to as “electric wire region image”) 50 is an image of an electric wire region of a power line 400 or the like, which is an inspection object having an elongated shape as shown in FIG. 2, and is acquired by aerial photography using an aircraft such as a helicopter or an unmanned aerial vehicle such as a drone.

The abnormal region detection unit 10 is constructed, for example, by training a mathematical model such as a convolutional neural network (CNN) through machine learning using, as teacher data, electric wire region images that include abnormal regions 52 and 420. After training, the abnormal region detection unit 10 detects abnormal region candidates from image features extracted from the electric wire region image 50 by image comparison, luminance value comparison, or the like.

The abnormal periodicity determination unit 12 determines whether or not the abnormal region candidates detected by the abnormal region detection unit 10 exhibit periodicity. For example, in the case of anti-snow-adhesion rings 410 and electric wires with fins, abnormal region candidates tend to be continuously detected. The determination of the periodicity of the abnormal region candidates by the abnormal periodicity determination unit 12 is performed, for example, based on any of the following:
(1) the magnitude of variance of the distances between the abnormal region candidates,
(2) the degree of deviation of each distance between the abnormal region candidates from a median of the distances between the abnormal region candidates, or
(3) luminance values of pixels in the electric wire region.

The determination (1) based on the magnitude of the variance of the distances between the abnormal region candidates is specifically performed as follows. Distances di (i=1, 2, 3, . . . , n; n is the total number of samples of distances between adjacent abnormal region candidates) between adjacent abnormal region candidates are obtained, and whether there is variation in the distances between the abnormal region candidates is determined based on the value of the variance s² of the distances di as expressed by Equation (1) below. The distances between the abnormal region candidates are measured based on the number of pixels between the abnormal regions in the electric wire region image 50. The abnormal periodicity determination unit 12 determines that the abnormal region candidates detected by the abnormal region detection unit 10 exhibit periodicity when the value of the variance s² is equal to or less than a predetermined variance threshold. The variance threshold is determined, for example, by comparing and evaluating the values of the variance s² calculated respectively from an electric wire region image of an electric wire to which members such as the anti-snow-adhesion rings 410 are attached, and an electric wire region image of an electric wire having abnormal regions such as damages in addition to the members such as the anti-snow-adhesion rings 410. Alternatively, when the abnormal periodicity determination unit 12 is constructed by machine learning using, as training data, an electric wire region image of an electric wire to which members such as the anti-snow-adhesion rings 410 are attached and an electric wire region image of an electric wire having abnormal regions such as damages in addition to the members such as the anti-snow-adhesion rings 410, the abnormal periodicity determination unit 12 may be configured to retain the variance threshold as a result of the machine learning.

$${s}^{2} = \frac{1}{n} {\sum }_{i = 1}^{n} {( {d}_{i} - \overline{d} )}^{2} \qquad ( 1 )$$

d̅ is an average value of di.

In the case where the determination is made based on the degree of deviation of each distance between the abnormal region candidates from the median of the distances between the abnormal region candidates (2), the abnormal periodicity determination unit 12, similarly to the above item (1), measures the distances between the abnormal region candidates based on the number of pixels between the abnormal regions in the electric wire region image 50, and extracts the median of the distances between adjacent abnormal region candidates. The abnormal periodicity determination unit 12 then calculates the number of distance samples between the abnormal region candidates that fall within a predetermined range from the median, and determines that the abnormal region candidates detected by the abnormal region detection unit 10 exhibit periodicity when the ratio of the number to the total number n of samples is equal to or greater than a predetermined ratio threshold. The predetermined range from the median and the ratio threshold are determined, for example, by comparing and evaluating the values of the distances di between the abnormal region candidates, which are respectively calculated from an electric wire region image of an electric wire to which members such as the anti-snow-adhesion rings 410 are attached, and from an electric wire region image of an electric wire having abnormal regions such as damage in addition to members such as the anti-snow-adhesion rings 410. Alternatively, if the abnormal periodicity determination unit 12 is constructed by machine learning using, as training data, an electric wire region image of an electric wire to which members such as the anti-snow-adhesion rings 410 are attached and an electric wire region image of an electric wire having abnormal regions such as damage in addition to members such as the anti-snow-adhesion rings 410, then, as a result of the machine learning, the abnormal periodicity determination unit 12 may be configured to retain the predetermined range and the ratio threshold.

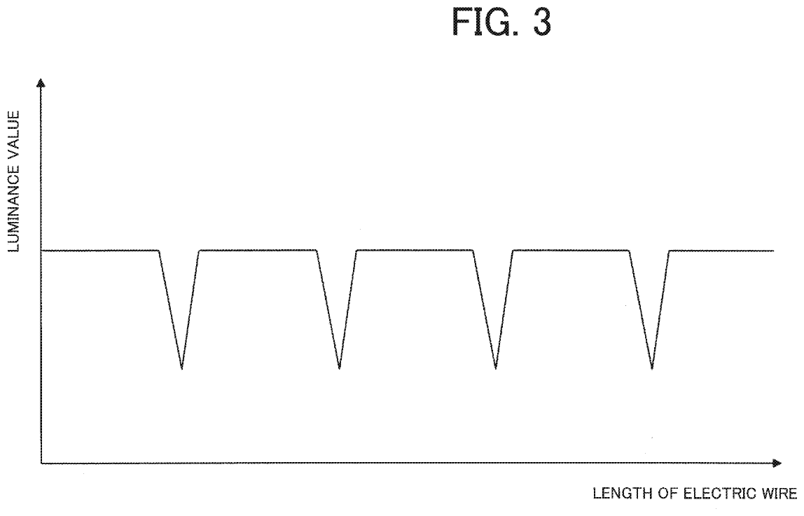

The determination (3) based on the luminance values of pixels in the electric wire region is performed by calculating the average luminance value for each column in the electric wire region and determining whether the abnormal region candidates exhibit periodicity from a graph, such as that shown in FIG. 3, in which the horizontal axis represents the length (longitudinal distance) of the electric wire and the vertical axis represents the average luminance value of each column in the electric wire region. Each column in the electric wire region refers to each of the pixel columns orthogonal to the pixel rows indicating the electric wire in the electric wire region image 50. The abnormal periodicity determination unit 12 determines that the abnormal region candidates detected by the abnormal region detection unit 10 exhibit periodicity when portions showing approximately similar luminance values are present at substantially regular intervals in the above-described graph. For example, since members such as the anti-snow-adhesion rings 410 are often made of black resin, the luminance values show minimum values at regular intervals in FIG. 3.

The abnormal periodicity determination unit 12 transfers the processing to the subsequent abnormal image comparison unit 14 when the abnormal region candidates detected by the abnormal region detection unit 10 exhibit periodicity. In addition, when the abnormal region candidate detected by the abnormal region detection unit 10 does not exhibit periodicity, the abnormal periodicity determination unit 12 outputs the abnormal region candidate as the abnormal region 52.

When the abnormal region candidates exhibit periodicity, the abnormal image comparison unit 14 compares respective images of the abnormal region candidates and calculates the degree of similarity between the images. The degree of similarity of the images is, for example, the sum of squared deviations of luminance values of pixels that are respectively located at corresponding positions in each image of the two abnormal region candidates to be compared. The closer this sum of squared deviations is to zero, the higher the degree of similarity between the two images. The abnormal image comparison unit 14 determines that the two images have a degree of similarity equal to or greater than a certain level when the calculated sum of squared deviations is equal to or less than a predetermined similarity threshold. The similarity threshold is determined, for example, by comparing and evaluating the values of the sum of squared deviations of luminance values of pixels that are respectively located at corresponding positions in each image of the two abnormal region candidates, which are the comparison subjects, extracted respectively from an electric wire region image of an electric wire to which members such as the anti-snow-adhesion rings 410 are attached, and from an electric wire region image of an electric wire having abnormal regions such as damage in addition to members such as the anti-snow-adhesion rings 410. Alternatively, if the abnormal periodicity determination unit 12 is constructed by machine learning using, as training data, an electric wire region image of an electric wire to which members such as the anti-snow-adhesion rings 410 are attached and an electric wire region image of an electric wire that has abnormal regions such as damages in addition to the members such as the anti-snow-adhesion rings 410, then, as a result of such machine learning, the abnormal periodicity determination unit 12 may be configured to retain the similarity threshold.

The normal region removal unit 16 determines that, when the degree of similarity of the images of abnormal region candidates is equal to or greater than a predetermined level, the corresponding abnormal region candidates are special-shaped electric wires, such as the anti-snow-adhesion rings 410 or electric wires with fins, that exhibit periodicity. The normal region removal unit 16 regards abnormal region candidates whose degree of similarity is equal to or greater than the predetermined level as normal regions, excludes them from the abnormality detection results, and outputs the remaining abnormal region candidate, after exclusion, as the abnormal region 52.

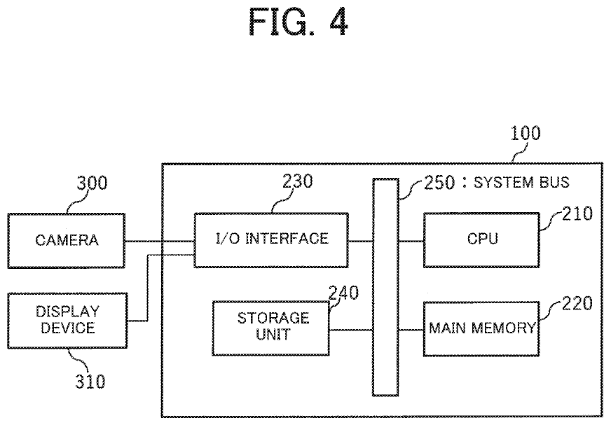

FIG. 4 is a hardware configuration diagram showing the abnormal region detection apparatus 100 according to the first embodiment. The abnormal region detection apparatus 100 includes a CPU (Central Processing Unit) 210, a main memory 220, an input/output interface (I/O interface) 230, and a storage unit 240, each of which is connected to one another via a system bus 250. The abnormal region detection apparatus 100 may be composed of a plurality of computers.

The CPU 210 is an integrated circuit (IC) that performs arithmetic processing. Instead of the CPU 210, a computational element such as a Digital Signal Processor (DSP) or a Graphics Processing Unit (GPU) may also be used. By executing an abnormal region detection program, the CPU 210 functions as: an abnormal region detection function for detecting abnormal region candidates from the electric wire region image 50; an abnormal periodicity determination function for determining whether the abnormal region candidates detected by the abnormal region detection function exhibit periodicity; an abnormal image comparison function for comparing the images of each abnormal region candidate and calculating the degree of similarity between the images when the abnormal region candidates exhibit periodicity; and a normal region removal function for treating abnormal region candidates whose degree of similarity is equal to or greater than a predetermined level as normal regions, excluding them from the abnormal detection result, and outputting the remaining abnormal region candidate as the abnormal region 52. As a result, by executing the abnormal region detection program, the CPU 210 functions as the abnormal region detection unit 10, the abnormal periodicity determination unit 12, the abnormal image comparison unit 14, and the normal region removal unit 16. The abnormal region detection program may, for example, be provided on a recording medium in which the program is stored. The recording medium may be a non-transitory computer-readable storage medium storing a program such as the abnormal region detection program.

The main memory 220 is constituted by a volatile storage device such as a Random Access Memory (RAM) or a nonvolatile storage device such as a Read Only Memory (ROM). The storage unit 240 is constituted by a nonvolatile storage device such as a Hard Disk Drive (HDD) or a flash memory.

The I/O interface 230 is a port to which a camera 300 as an input device and a display device 310 as an output device are connected. The I/O interface 230 is, for example, a Universal Serial Bus (USB) terminal, an IEEE 1394 terminal, or a Thunderbolt terminal, and further includes a communication interface such as Ethernet (registered trademark). The camera 300 is an imaging device that captures the electric wire region image 50 by means such as aerial photography and inputs the captured electric wire region image 50 to the abnormal region detection apparatus 100 by being connected to the I/O interface 230. In the present embodiment, it is assumed that the camera 300 is connected to the I/O interface 230 after aerial photography is performed using an aircraft such as a helicopter. However, if the I/O interface 230 and the camera 300 are each capable of wireless communication, the electric wire region image 50 captured by the camera 300 may be input to the I/O interface 230 in real time via wireless communication. The display device 310 is, for example, a display, but may also include a printer or other devices for outputting information.

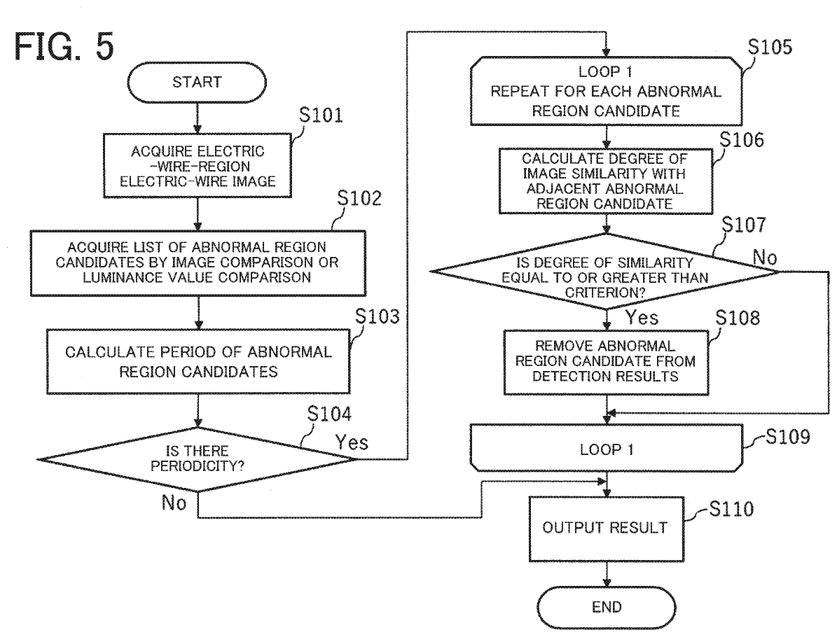

FIG. 5 is a flowchart showing an example of the determination processing performed by the abnormal region detection apparatus 100 according to the first embodiment. In step S101, the electric wire region image 50 captured by the camera 300 is acquired via the I/O interface 230.

In step S102, the abnormal region detection unit 10 detects abnormal region candidates by image comparison or luminance value comparison, and creates a list of the detected abnormal region candidates.

In step S103, the abnormal periodicity determination unit 12 calculates the period of the abnormal region candidates. In the first embodiment, as described above, the periodicity of the abnormal region candidates is calculated based on any of (1) the variance of the distances between the abnormal region candidates, (2) the distances between the abnormal region candidates relative to the median of the distances between the abnormal region candidates, or (3) the luminance values of pixels in the electric wire region.

In step S104, the abnormal periodicity determination unit 12 determines whether or not the abnormal region candidates exhibit periodicity. If the abnormal region candidates exhibit periodicity in step S104, the procedure proceeds to step S105. If the abnormal region candidates do not exhibit periodicity, the abnormal region candidates detected by the abnormal region detection unit 10 are regarded as the abnormal regions 52, and the procedure proceeds to step S110.

In step S105, a loop 1 is initiated to repeat the procedures from step S106 to step S108 for each abnormal region candidate. In step S106, the abnormal image comparison unit 14 calculates the degree of similarity between the images of adjacent abnormal region candidates. In the first embodiment, as described above, the degree of similarity between images is defined as the sum of squares of the deviations of luminance values of pixels located at corresponding positions in each image of the two abnormal region candidates to be compared. The closer this sum of squares is to zero, the higher the degree of similarity between the two images.

In step S107, the abnormal image comparison unit 14 determines whether the degree of similarity is equal to or greater than a predetermined criterion. The abnormal image comparison unit 14 determines that the degree of similarity between the two images is equal to or greater than the criterion when the sum of squares of the deviations of the pixel luminance values between the two abnormal region candidates being compared is equal to or less than a predetermined similarity threshold. If, in step S107, the degree of similarity is equal to or greater than the criterion, the procedure proceeds to step S108. If the degree of similarity is not equal to or greater than the criterion, the procedure proceeds to step S109. In the first embodiment, an abnormal region candidate whose degree of similarity is not equal to or greater than the criterion has a likelihood of being the abnormal region 52. However, in the first embodiment, since the degree of similarity is determined between adjacent abnormal region candidates as described above, it is not possible to determine that the two adjacent abnormal region candidates are abnormal regions 52 solely based on the degree of similarity between those two adjacent abnormal region candidates. This is because, even if the degree of similarity between two adjacent abnormal region candidates is not equal to or greater than the criterion, each of those candidates may have a degree of similarity equal to or greater than the criterion with other adjacent abnormal region candidates. In the first embodiment, since normal regions are sequentially excluded from the detection results, the abnormal region candidate that have not been excluded as a normal region after completing the process of the loop 1 for all abnormal region candidates is determined to be the abnormal region 52.

In step S108, the normal region removal unit 16 regards abnormal region candidates whose degree of similarity is equal to or greater than the criterion as normal regions and excludes them from among the abnormal region candidates that the abnormal periodicity determination unit 12 has determined to exhibit periodicity. In the first embodiment, since the degree of similarity between adjacent abnormal region candidates is determined as described above, when the degree of similarity is equal to or greater than the criterion, each of the two adjacent abnormal region candidates involved in calculating the degree of similarity is regarded as a normal region.

In step S109, the normal region removal unit 16 determines whether the degree of similarity has been determined for all of the abnormal region candidates that were determined to exhibit periodicity. If the degree of similarity has been determined for all of the abnormal region candidates determined to exhibit periodicity, the process of the loop 1 is terminated and the procedure proceeds to step S110. If the degree of similarity has not been determined for all of the abnormal region candidates that were determined to exhibit periodicity, the process of the loop 1 from step S106 to step S108 is executed.

In step S110, together with the abnormal region candidate determined in step S104 to not exhibit periodicity, the normal region removal unit 16 outputs, to the display device 310 as the abnormal regions 52, the abnormal region candidate obtained by excluding, from the abnormal region candidates determined to exhibit periodicity, the abnormal region candidates that have been regarded as normal regions, and then terminates the processing.

As described above, in the first embodiment, the abnormal periodicity determination unit 12 determines whether or not each abnormal region candidate exhibit periodicity. When an abnormal region candidate exhibit periodicity, the abnormal image comparison unit 14 performs image comparison between the abnormal region candidates exhibiting periodicity to determine the degree of similarity. Then, when the degree of similarity between the abnormal region candidates is high, the normal region removal unit 16 assumes that the corresponding locations are parts of the special-shaped electric wire, such as the anti-snow-adhesion rings 410 or the electric wires with fins uniformly existing along the electric wire, and excludes those locations from the abnormality detection results. As a result, by excluding normal regions such as the anti-snow-adhesion rings 410 from the abnormal region candidates, even when a plurality of abnormal regions 52 exhibit periodicity, it becomes possible to distinguish between the abnormal regions 52 and the normal regions.

According to the first embodiment, since it is possible to remove non-abnormal regions from the detected abnormal region candidates in a state in which even minor abnormal regions can be detected, abnormal regions excluding normal portions can be accurately detected while keeping the detection sensitivity for abnormal region candidates high. In addition, by reducing normal portions that are not abnormal from the abnormal region candidates, it is possible to shorten the time required for result verification and subsequent processing.

### Second Embodiment

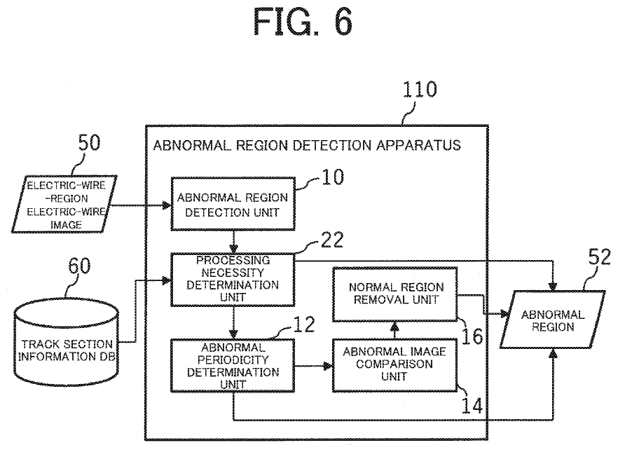

Next, an abnormal region detection apparatus 110 according to a second embodiment will be described. The abnormal region detection apparatus 110 according to the second embodiment, shown in FIG. 6, differs from that of the first embodiment in that the abnormal region detection apparatus 110 includes a track section information database (DB) 60, in which track sections (sections) using special-shaped electric wires, such as the anti-snow-adhesion rings 410 or electric wires with fins are pre-registered, and a processing necessity determination unit 22 (e.g., processing necessity determination circuitry) that refers to the track section information DB 60 to determine whether to execute the processing for removing normal regions according to the first embodiment. However, since the other configurations are the same as those of the first embodiment, identical reference numerals are assigned to the same components as in the first embodiment, and detailed descriptions thereof will be omitted. Moreover, the hardware configuration of the second embodiment is the same as the hardware configuration of the first embodiment, so a detailed description thereof will also be omitted. In the second embodiment, however, the CPU 210 functions not only as an abnormal region detection function, an abnormal periodicity determination function, an abnormal image comparison function, and a normal region removal function, but also as a processing necessity determination function that refers to the track section information DB 60 to determine whether to execute the processing for removing normal regions according to the first embodiment. As a result, by executing the abnormal region detection program, the CPU 210 functions as the abnormal region detection unit 10, the abnormal periodicity determination unit 12, the abnormal image comparison unit 14, the normal region removal unit 16, and the processing necessity determination unit 22.

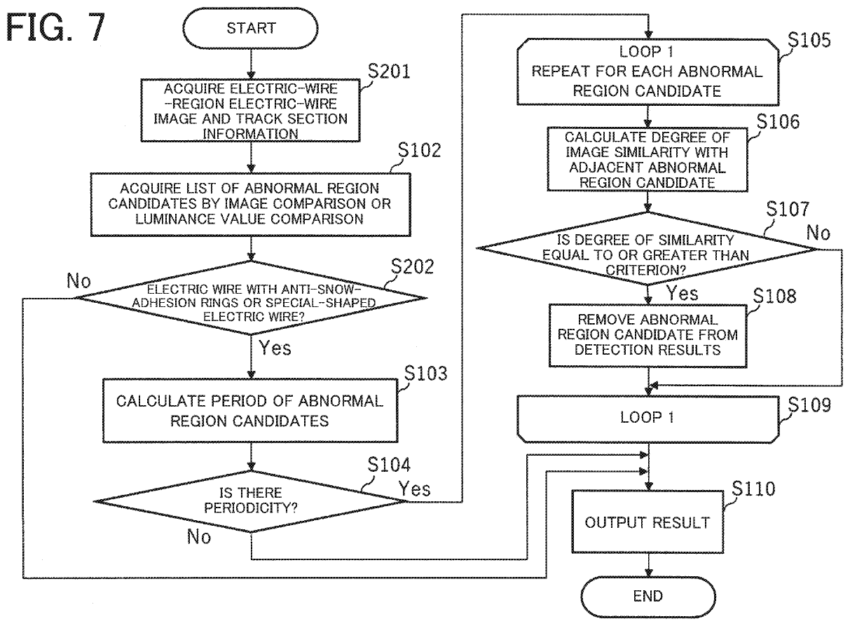

FIG. 7 is a flowchart showing an example of the determination processing performed by the abnormal region detection apparatus 110 according to the second embodiment. The flowchart shown in FIG. 7 differs from that of the first embodiment in that the flowchart includes step S201, in which the track section information, which is information on the track sections using special-shaped electric wires such as the anti-snow-adhesion rings 410 or electric wires with fins, is obtained from the track section information DB 60 together with the electric wire region image 50; and step S202, in which it is determined, with reference to the track section information, whether the track section in which the abnormal region candidate detected by the abnormal region detection unit 10 exists corresponds to a track section using a special-shaped electric wire. However, since the other procedures are the same as those in the first embodiment, the same reference numerals are assigned to the same steps as those in the first embodiment, and detailed descriptions thereof will be omitted.

In step S201, the abnormal region detection unit 10 acquires the electric wire region image 50, and the processing necessity determination unit 22 acquires the track section information by referring to the track section information DB 60. Similarly to the first embodiment, in step S102, the abnormal region detection unit 10 detects abnormal region candidates from the electric wire region image 50 by means of image comparison or luminance value comparison, and creates a list of the detected abnormal region candidates.

In step S202, the processing necessity determination unit 22 determines whether the abnormal region candidates detected by the abnormal region detection unit 10 belong to a track section in which a special-shaped electric wire is used. If, in step S202, the detected abnormal region candidates belong to the track section in which the special-shaped electric wire is used, the procedure proceeds to step S103; if the detected abnormal region candidates do not belong to the track section in which the special-shaped electric wire is used, the detected abnormal region candidates are regarded as abnormal regions 52, and the procedure proceeds to step S110.

In step S110, similar to the first embodiment, the abnormal regions 52 detected through the process of the loop 1 composed of the procedures from step S105 to step S109, as well as the abnormal regions 52 detected in step S104 and step S202, are output to the display device 310, and the processing is then completed.

As described above, in the second embodiment, when an abnormal region candidate detected by the abnormal region detection unit 10 is located in a position registered in the track section information DB 60, processing for removing the normal regions according to the first embodiment is executed. When the abnormal region candidate is not located in a position registered in the track section information DB 60, the abnormal region candidate is output as the abnormal region 52. As a result, the likelihood of erroneously removing the abnormal region 52 as a normal region is suppressed, and the abnormal region 52 on the electric wire can be accurately detected.

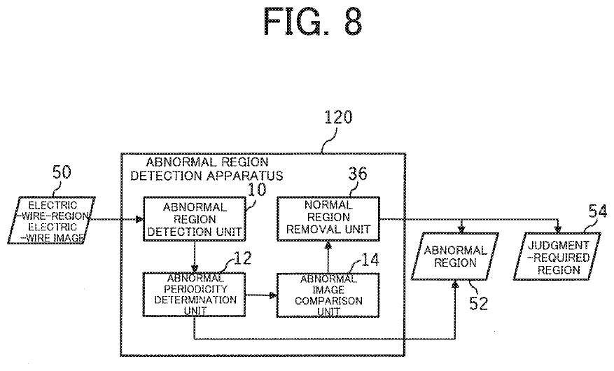

Next, an abnormal region detection apparatus 120 according to a third embodiment will be described. The abnormal region detection apparatus 120 according to the third embodiment, shown in FIG. 8, differs from that of the first embodiment in that the normal region removal unit 36 (e.g., normal region removal circuitry) classifies and outputs the abnormal region candidates into the abnormal regions 52 and judgment-required regions 54, which must ultimately be determined by personnel, based on the degree of similarity between the abnormal region candidates. However, since the other configurations are the same as those of the first embodiment, identical reference numerals are assigned to the same components as in the first embodiment, and detailed descriptions thereof will be omitted. Furthermore, since the hardware configuration of the third embodiment is the same as the hardware configuration of the first embodiment, so a detailed description thereof will also be omitted.

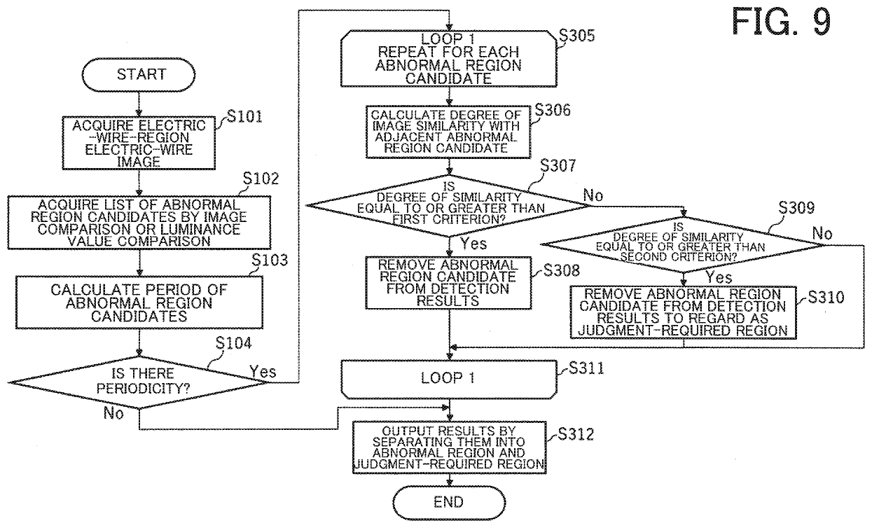

FIG. 9 is a flowchart showing an example of the determination processing performed by the abnormal region detection apparatus 120 according to the third embodiment. In the flowchart shown in FIG. 9, the process of the loop 1 from step S305 to step S311 differs from that of the first embodiment in that adjacent abnormal region candidates whose degree of similarity is equal to or greater than a first threshold are regarded as normal regions, and those abnormal region candidates whose degree of similarity is not equal to or greater than the first threshold but is equal to or greater than a second threshold, which is lower than the first threshold, are classified as the judgment-required regions 54 to be judged by a user. However, since the other procedures are the same as those in the first embodiment, the same reference numerals are assigned to the same steps as those in the first embodiment, and detailed descriptions thereof will be omitted.

In step S305, a loop 1 is started in which the procedures from step S306 to step S310 are repeated for each abnormal region candidate. In step S306, the abnormal image comparison unit 14 calculates the degree of similarity between adjacent abnormal region candidates. As in the first embodiment, the degree of similarity of images is the sum of squared deviations of luminance values of pixels that are respectively located at corresponding positions in each image of the two abnormal region candidates to be compared. The closer the sum of squared deviations is to zero, the higher the degree of similarity between the two images.

In step S307, the abnormal image comparison unit 14 determines whether the abnormal region candidates determined in step S104 to exhibit periodicity have a high degree of similarity, specifically, whether the degree of similarity is equal to or greater than a first criterion. When the sum of squared deviations of the luminance values of corresponding pixels between the two abnormal region candidates to be compared is less than or equal to a predetermined first similarity threshold, the abnormal image comparison unit 14 determines that the degree of similarity between the two images is equal to or greater than the first criterion. If, in step S307, the degree of similarity is equal to or greater than the first criterion, the procedure proceeds to step S308, and if the degree of similarity is not equal to or greater than the first criterion, the procedure proceeds to step S309.

In step S308, the normal region removal unit 36 regards the abnormal region candidates whose degree of similarity is equal to or greater than the first criterion as normal regions, and excludes them from the abnormal region candidates determined to exhibit periodicity in step S104. In the third embodiment, since the degree of similarity between adjacent abnormal region candidates is determined as described above, when the degree of similarity becomes equal to or greater than the first criterion, each of the two adjacent abnormal region candidates involved in calculating the degree of similarity is regarded as a normal region.

In step S309, the abnormal image comparison unit 14 determines whether the abnormal region candidates determined in step S307 as having a degree of similarity lower than the first criterion exhibit a moderate degree of similarity, specifically, whether the degree of similarity is equal to or greater than a second criterion that is lower than the first criterion. When the sum of squared deviations of the luminance values of corresponding pixels between the two abnormal region candidates to be compared is less than or equal to a second similarity threshold that is greater than the first similarity threshold, the abnormal image comparison unit 14 determines that the degree of similarity between the two images is equal to or greater than the second criterion. If, in step S309, the degree of similarity is equal to or greater than the second criterion, the procedure proceeds to step S310, and if the degree of similarity is not equal to or greater than the second criterion, the procedure proceeds to step S311. In the third embodiment, the abnormal region candidates whose degree of similarity is not equal to or greater than the second criterion have a likelihood of being abnormal regions 52. However, in the third embodiment, since the degree of similarity between adjacent abnormal region candidates is determined as described above, it is not possible to determine that the two adjacent abnormal region candidates are the abnormal regions 52 based only on the degree of similarity between the two adjacent abnormal region candidates. Even if two abnormal region candidates do not have a degree of similarity equal to or greater than the second criterion, it is possible that each of the two abnormal region candidates has a degree of similarity equal to or greater than the first criterion or the second criterion with other adjacent abnormal region candidates. In the third embodiment, since the normal regions or judgment-required regions described later are sequentially excluded from the detection results, after the process of loop 1 is executed for all abnormal region candidates, the abnormal region candidate that have not been excluded as normal regions or judgment-required regions become the abnormal region 52.

Each of the first similarity threshold and the second similarity threshold is determined, for example, by comparatively evaluating the values of the sum of squared deviations of luminance values of pixels that are respectively located at corresponding positions in each image of the two abnormal region candidates to be compared, which are respectively extracted from an electric wire region image of an electric wire to which members such as the anti-snow-adhesion rings 410 are attached, and from an electric wire region image of an electric wire having abnormal regions such as damage in addition to members such as the anti-snow-adhesion rings 410. Alternatively, if the abnormal periodicity determination unit 12 is constructed by machine learning using, as training data, the electric wire region image of an electric wire to which a members such as the anti-snow-adhesion rings 410 are attached and an electric wire region image of an electric wire that has abnormal regions such as damage in addition to members such as the anti-snow-adhesion rings 410, then, as a result of the machine learning, the abnormal periodicity determination unit 12 may be configured to retain the first similarity threshold and the second similarity threshold.

In step S310, the normal region removal unit 36 regards the abnormal region candidates having a degree of similarity equal to or greater than the second criterion as judgment-required regions 54, and excludes the abnormal region candidates that have been determined in step S307 not to have a degree of similarity equal to or greater than the first criterion. In the third embodiment, since the degree of similarity between adjacent abnormal region candidates is determined as described above, when the degree of similarity becomes equal to or greater than the second criterion, each of the two adjacent abnormal region candidates involved in the calculation of the degree of similarity is regarded as a judgment-required region.

In step S311, the normal region removal unit 36 determines whether the degree of similarity has been determined for all abnormal region candidates that were determined to exhibit periodicity. If the degree of similarity has been determined for all abnormal region candidates determined to exhibit periodicity, the process of loop 1 is completed, and the procedure proceeds to step S312. If the degree of similarity has not been determined for all abnormal region candidates that were determined to have periodicity, the process of loop 1 from step S306 to step S310 is executed.

In step S312, each of the detected abnormal region 52 and the judgment-required region 54, as described above, is output to the display device 310, and the processing is completed.

As described above, in the third embodiment, the abnormal region candidates detected in the same manner as in the first or second embodiment are classified by levels based on their degrees of similarity. The abnormal region candidates having a high degree of similarity, which are highly likely to be normal regions, are removed as normal regions, while the abnormal region candidate having a low degree of similarity is output as the abnormal region 52. The abnormal region candidate having a medium degree of similarity, which do not correspond to either normal region or the abnormal region 52, is presented to the user via the display device 310, allowing the user to determine whether to exclude them. As a result, the abnormal region candidate that do not correspond to either a normal region or the abnormal region 52 can have normal regions more accurately removed by incorporating user judgment.

### Fourth Embodiment

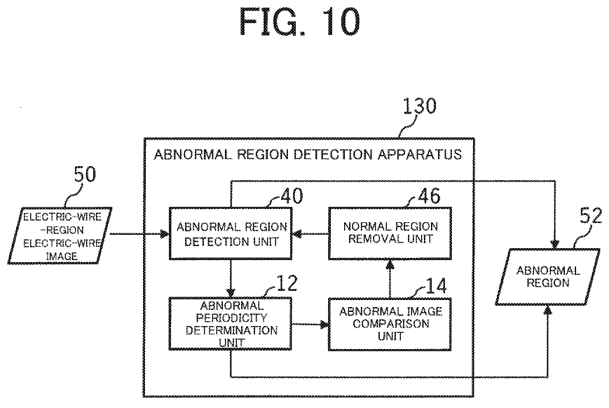

Next, a description will be given of an abnormal region detection apparatus 130 according to a fourth embodiment. The abnormal region detection apparatus 130 according to the fourth embodiment, shown in FIG. 10, differs from the first embodiment in that a normal region removal unit 46 (e.g., normal region removal circuitry) regards abnormal region candidates having a degree of similarity equal to or greater than a predetermined level as normal regions, excludes such abnormal region candidates from the abnormal region candidates, and transmits the result to an abnormal region detection unit 40 (e.g., abnormal region detection circuitry), and the abnormal region detection unit 40 performs image comparison or luminance value comparison again on the abnormal region candidates from which the normal regions have been removed, and outputs the detected abnormal region candidates as the abnormal region 52. However, since the other configurations are the same as those of the first embodiment, the same reference numerals are used for the same components as in the first embodiment, and detailed descriptions thereof will be omitted. In addition, since the hardware configuration of the fourth embodiment is the same as that of the first embodiment, a detailed description thereof will also be omitted.

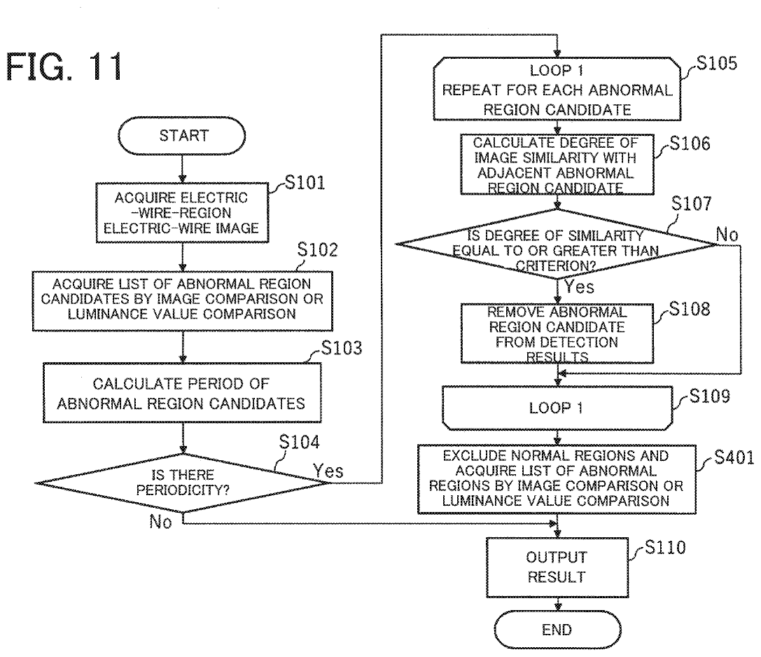

FIG. 11 is a flowchart showing an example of the determination processing of the abnormal region detection apparatus 130 according to the fourth embodiment. The flowchart shown in FIG. 11 differs from that of the first embodiment in that the flowchart includes step S401, in which image comparison or luminance value comparison is performed again on the abnormal region candidates from which normal regions have been removed, to detect the abnormal region 52. However, since the other procedures are the same as those in the first embodiment, the same reference numerals are assigned to the corresponding steps, and detailed descriptions thereof will be omitted.

In step S401, through the process of loop 1, the abnormal region detection unit 40 performs detection of an abnormal region again by image comparison or luminance value comparison on the abnormal region candidates from which normal regions have been removed. The abnormal region candidate detected as the abnormal region in step S401 is extracted as the abnormal region 52.

In step S110, the abnormal region candidate determined to exhibit no periodicity in step S104 and the abnormal region candidate detected in step S401 are output to the display device 310 as the abnormal regions 52, and the processing is then completed.

As described above, in the fourth embodiment, the abnormal region detection unit 40 again determines, as the abnormal region 52, the abnormal region candidate that have been detected as an abnormal region after the normal regions have been excluded. As previously explained, the abnormal image comparison unit 14 indicates the degree of similarity based on the sum of squared deviations of luminance values of pixels that are respectively located corresponding positions in each image of the two abnormal region candidates to be compared. For example, when comparing a normal region and the abnormal region 52, if the sum of squared deviations of luminance values of pixels that are respectively located at corresponding positions is close to zero, the abnormal image comparison unit 14 may erroneously determine the abnormal region 52 as a normal region. In the fourth embodiment, the abnormal region detection is performed again on the abnormal region candidates that may include the abnormal region 52 erroneously determined as a normal region. As a result, the abnormal region 52 can be accurately detected.

### Modified Example

In the first to fourth embodiments, the inspection target is described as an electric wire, but it is not limited thereto. For example, abnormal regions may also be detected in elongated structures such as railway overhead wires, railway tracks, tunnels, and pipelines. The railway overhead wires and railway tracks can have abnormal regions detected using procedures similar to those described in the first to fourth embodiments. For example, since the joint portions of railway tracks are provided at regular intervals, they can be excluded from the abnormal region candidates as normal regions exhibiting periodicity. In the case of a tunnel, abnormal region candidates such as cracks on the inner wall can be detected from an image of the tunnel interior, and seams generated between work sections during concrete placement can be removed from the abnormal region candidates as normal regions by determining periodicity or the degree of similarity. Similarly, in the case of a pipeline, abnormal region candidates such as rust or deformation of the pipe can be detected from an image of the pipeline exterior, and members such as flanges that join adjacent pipes can be removed from the abnormal region candidates as normal regions by determining periodicity or the degree of similarity.

### DESCRIPTION OF REFERENCE CHARACTERS

10: abnormal region detection unit, 12: abnormal periodicity determination unit, 14: abnormal image comparison unit, 16: normal region removal unit, 22: processing necessity determination unit, 36: normal region removal unit, 40: abnormal region detection unit, 46: normal region removal unit, 52: abnormal region, 54: determination-required region, 60: track section information database (track section information DB), 100, 110, 120, 130: abnormal region detection apparatus, 210: CPU, 220: main memory, 230: I/O interface, 240: storage unit, 300: camera, 310: display device.

What is claimed is:

1. An abnormal region detection apparatus comprising:
abnormal region detection circuitry to detect abnormal region candidates from image features included in a captured image of an inspection object having an elongated shape, the abnormal region candidates being candidates for abnormal regions;
abnormal periodicity determination circuitry to determine periodicity of the abnormal region candidates;
abnormal image comparison circuitry to compare images of the respective abnormal region candidates that exhibit periodicity, and to calculate a degree of similarity of the respective abnormal region candidates; and
normal region removal circuitry to exclude, as normal regions, the abnormal region candidates whose degree of similarity calculated by the abnormal image comparison circuitry is higher than a predetermined threshold, and to output, as an abnormal region, the abnormal region candidate other than the excluded abnormal region candidates.

2. The abnormal region detection apparatus according to claim 1, further comprising:
a track section information database in which sections of the inspection object having special shapes are registered in advance; and
processing necessity determination circuitry to refer to the track section information database, to determine whether the abnormal region candidates belong to the sections having the special shapes registered in the track section information database, and to output, as the abnormal region, the abnormal region candidates that do not belong to the sections having the special shapes,
wherein the abnormal periodicity determination circuitry determines periodicity of the abnormal region candidates that belong to the sections having the special shapes determined by the processing necessity determination circuitry.

3. The abnormal region detection apparatus according to claim 1, wherein the normal region removal circuitry excludes, as the normal region, the abnormal region candidates whose the degree of similarity is equal to or greater than a first criterion, excludes, as determination-required regions, the abnormal region candidates whose the degree of similarity is smaller than the first criterion but is equal to or greater than a second criterion smaller than the first criterion, and outputs, as the abnormal regions together with the determination-required regions, the abnormal region candidates with the normal regions and the determination-required regions excluded.

4. The abnormal region detection apparatus according to claim 1, wherein, with respect to the abnormal region candidates from which the normal regions have been excluded by the normal region removal circuitry, the abnormal region detection circuitry performs detection of abnormal region candidates again and outputs the detected abnormal region candidate as the abnormal region.

5. The abnormal region detection apparatus according to claim 1, wherein the abnormal periodicity determination circuitry determines the periodicity of the plurality of abnormal region candidates based on a variance of respective distances between adjacent ones of the abnormal region candidates.

6. The abnormal region detection apparatus according to claim 1, wherein the abnormal periodicity determination circuitry determines the periodicity of the plurality of the abnormal region candidates based on a degree of deviation of each distance between adjacent ones of the abnormal region candidates from a median of the distances between the adjacent ones of the abnormal region candidates.

7. The abnormal region detection apparatus according to claim 1, wherein the abnormal periodicity determination circuitry calculates an average luminance value of pixels of the inspection object along a column perpendicular to a longitudinal direction of the inspection object in the captured image of the inspection object, and determines that the abnormal region candidates have the periodicity when the average luminance value exhibits similar luminance values at substantially regular intervals in a distance along the longitudinal direction of the inspection object.

8. An abnormal region detection method executed by a computer, comprising:
detecting abnormal region candidates, which are candidates for abnormal regions, from image features included in a captured image of an inspection object having an elongated shape;
determining periodicity of the abnormal region candidates;
comparing images of the respective abnormal region candidates that exhibit periodicity to calculate a degree of similarity of the respective abnormal region candidates; and
excluding, as normal regions, the abnormal region candidates whose calculated degree of similarity is higher than a predetermined threshold to output, as an abnormal region, the abnormal region candidate other than the excluded abnormal region candidates.

9. A non-transitory computer-readable storage medium storing an abnormal region detection program for causing a computer to execute:
detecting abnormal region candidates, which are candidates for abnormal regions, from image features included in a captured image of an inspection object having an elongated shape;
determining periodicity of the abnormal region candidates;
comparing images of the respective abnormal region candidates that exhibit periodicity to calculate a degree of similarity of the respective abnormal region candidates; and
excluding, as normal regions, the abnormal region candidates whose calculated degree of similarity is higher than a predetermined threshold to output, as an abnormal region, the abnormal region candidate other than the excluded abnormal region candidates.
